(19) United States
(12) Patent Application Publication
(10) Pub. No.: US 2006/0057331 A1
(43) Pub. Date: Mar. 16, 2006

(54) Self-adhesive prepreg

(76) Inventor: Scott Douglas Lucas, Mesa, AZ (US)

Correspondence Address: CYTEC INDUSTRIES INC., 1937 WEST MAIN STREET, P.O. BOX 60, STAMFORD, CT, 06904-0060, US

(21) Appl. No.: 11/127,843

(22) Filed: May 12, 2005

Related U.S. Application Data
(60) Provisional application No. 60/571,449, filed on May 14, 2004.

(51) Int. Cl. B32B 3/12

(52) U.S. Cl. 428/117; 442/104; 442/172; 442/179

(57) ABSTRACT

Prepreg compositions comprised of fibers and a prepreg resin, comprising a thermosetting resin, a curing agent, and a plurality of thermoplastic polymers, in which greater than 10% of each of the thermoplastic polymers are soluble in the prepreg resin, are useful for making composite materials. In preferred embodiments, the prepreg compositions are used as self-adhesive prepregs for making honeycomb structures useful for various high performance applications.

### BACKGROUND OF THE INVENTION

1. Field of the Invention

This invention relates to compositions useful for making composite materials and, in preferred embodiments, to materials useful as self-adhesive prepregs for making sandwich structures, e.g. honeycomb sandwich structures.

2. Description of the Related Art

Composite materials are widely used for applications in which a structure having a high strength to weight ratio is desired. These materials generally contain reinforcing fibers (e.g., carbon or glass) that are embedded in a polymer matrix material (typically a thermoset polymer such as an epoxy polymer). Composite materials are typically made by impregnating the fibers with a matrix precursor (e.g., epoxy and curing agent) to form a “prepreg.” The prepreg is then molded into the desired shape and cured to convert the matrix precursor into the polymer matrix material.

Composite materials may be formed or incorporated into structures having various sizes, shapes and configurations, depending on the desired application. For example, sandwich structures are typically formed of face sheets bonded to the opposite sides of a core panel. Typical core panel materials include rigid foam, paper, wood and honeycomb. Honeycomb is a cellular structure that typically contains various materials such as Nomex® brand fibers (commercially available from DuPont) and/or aluminum. The face sheets are typically thin, lightweight panels made from various materials, including composite materials. Honeycomb sandwich structures having composite face sheets are widely used in the aerospace industry because of their generally favorable strength to weight ratios and fatigue resistance. Since the cell walls of the honeycomb core panel are typically at an angle to the face sheets, the contact area between the edges of the cell walls and the face sheets is relatively small. The strength of the bond between the face sheets and the honeycomb may be enhanced by using an adhesive that forms “fillets” extending along the cell walls beyond the contact areas.

The technology used to bond the honeycomb core to the face sheets has developed over the years. For example, U.S. Pat. No. 3,530,087 (issued in 1970) discloses adhesive compositions useful for bonding face sheets to honeycomb cores. Those adhesive compositions were made by heating an epoxide resin and a polysulphone polymer together to dissolve the polysulphone, adding a curing agent, then forming the resulting mixture into a film. The incorporation of fiber and metal powder fillers into the adhesive is mentioned. U.S. Pat. No. 3,530,087 discloses using the adhesive films to bond an aluminum face sheet to a cellular aluminum core. The inclusion of the polysulphone in the adhesive was said to improve the peel strength of the bond between the face sheet and the core.

A number of composite materials containing undissolved thermoplastic toughening agents were developed in subsequent years. The thermoplastics were in an undissolved form because, as disclosed in U.S. Pat. No. 4,945,154 (issued 1990), it was believed that the amount of thermoplastic which could be incorporated in the resin matrix was limited by the effects of the thermoplastic on the processing characteristics of the resulting thermosetting resin, specifically the viscosity and tack. According to the disclosure of U.S. Pat. No. 4,945,154, maintenance of the tack and flow (or acceptable viscosity) often meant that the thermoplastic could not be used at elevated loading levels considered necessary for the achievement of optimum mechanical properties. Thus, U.S. Pat. No. 4,945,154 discloses that dissolving polyethersulfone (PES) thermoplastics into the resin greatly increases the resin viscosity and reduces resin tack at PES levels far below those considered necessary to optimize the mechanical properties of the cured resin. Additional examples of the use of undissolved thermoplastic in composites include U.S. Pat. No. 4,604,319 (issued 1986); U.S. Pat. No. 4,957,801 (issued 1990); and U.S. Pat. No. 5,057,353 (issued 1991), in which the thermoplastic forms a discrete layer within the composite. Similarly, U.S. Pat. No. 5,169,710 (issued 1992) discloses composites toughened by the inclusion of polyamide particles; see also U.S. Pat. No. 6,045,898 (issued 2000) and U.S. Pat. No. 6,429,157 (issued 2002). The conventional wisdom was that the thermoplastic toughening agents in the prepregs used to form the composites should be undissolved as well.

Self-adhesive prepregs have been developed in recent years that allow the prepreg to be bonded to the core panel without using a separate adhesive. For honeycomb structures, U.S. Pat. No. 6,440,257 (issued 2002) discloses that thermoplastic particles, not dissolved to any substantial degree when they are loaded into the prepreg resin, may be used as fillet forming particles to make the prepreg self-adhesive while not adversely affecting the viscosity or other properties of the prepreg resin. During the curing process, U.S. Pat. No. 6,440,257 discloses that gradual dissolving of the fillet forming particles provides a gradual increase in resin viscosity which enhances fillet formation. Thus, the conventional wisdom remains that thermoplastic toughening agents in prepregs should not be dissolved to any substantial degree.

### SUMMARY OF THE INVENTION

Surprisingly, and contrary to conventional wisdom, prepreg compositions containing thermoplastic toughening agents have been discovered in which the thermoplastic toughening agent is substantially or completely soluble in the prepreg resin at ambient temperature. Preferred prepreg compositions may be processed to form composite materials by a wide array of manufacturing techniques, including hand layup and automated tape laying. The resulting composite materials may be incorporated into various composite structures, including primary and secondary aircraft structures. In preferred embodiments, the prepreg compositions are suitable as self-adhesive prepregs for use in making honeycomb sandwich structures.

A preferred embodiment provides a prepreg composition comprising at least one fiber layer impregnated with a prepreg resin; the prepreg resin comprising a thermosetting resin, a curing agent, a thermoplastic viscosity control agent, and a thermoplastic toughening agent, the combined amounts of the thermoplastic viscosity control agent and the thermoplastic toughening agent being in the range of about 25% to about 40%, by weight based on total prepreg resin weight; wherein more than 10% of each of the thermoplastic viscosity control agent and the thermoplastic toughening agent are soluble in the prepreg resin, by weight based on the total weight of each of the thermoplastic viscosity control agent and the thermoplastic toughening agent, respectively, as measured at about 25° C.; and wherein the prepreg resin has a minimum viscosity in the range of about 25 poise to about 1500 poise as measured on a neat prepreg resin sample at a heating rate of 2° C. per minute.

Another preferred embodiment provides a composite structure comprising a composite material made by curing the aforementioned prepreg composition. Preferably, the composite structure is in the form of a honeycomb sandwich structure.

Another preferred embodiment provides a method for making a prepreg composition, comprising: forming a prepreg resin comprising a thermosetting resin, optionally a curing agent, a thermoplastic viscosity control agent, and a thermoplastic toughening agent; the combined amounts of the thermoplastic viscosity control agent and the thermoplastic toughening agent being in the range of about 25% to about 40%, as measured by weight based on the total weight of a neat prepreg resin sample; wherein more than 10% of each of the thermoplastic viscosity control agent and the thermoplastic toughening agent are soluble in the prepreg resin, by weight based on the total weight of each of the thermoplastic viscosity control agent and the thermoplastic toughening agent, respectively, as measured at about 25° C.; wherein the prepreg resin has a minimum viscosity in the range of about 25 poise to about 1500 poise as measured on a neat prepreg resin sample at a heating rate of 2° C. per minute; and contacting a plurality of fibers with the prepreg resin.

The present invention further provides a homogeneous resin with controlled minimum viscosity. The resin is adaptable for full impregnation of a prepreg and for use with slit tape applications as well as with resin infusion technology. These and other embodiments are described in greater detail below.

### BRIEF DESCRIPTION OF THE DRAWINGS

Various aspects of the invention will be readily apparent from the following description and from the appended drawings, which are meant to illustrate and not to limit the invention.

FIG. 1 is the Rheometric study curve illustrating the viscosity as a function of the temperature for a 1° C. per minute increase in temperature for a preferred embodiment of the prepreg resin of the present invention.

FIG. 2 is the Rheometric study curve illustrating the viscosity as a function of the temperature for a 2° C. per minute increase in temperature for a preferred embodiment of the prepreg resin of the present invention.

FIG. 3 is the Rheometric study curve illustrating the viscosity as a function of the temperature for a 5° C. per minute increase in temperature for a preferred embodiment of the prepreg resin of the present invention.

FIG. 4 is the Rheometric study curve illustrating the viscosity as a function of the temperature for a 10° C. per minute increase in temperature for a preferred embodiment of the prepreg resin of the present invention.

### DETAILED DESCRIPTION OF THE PREFERRED EMBODIMENTS

Preferred embodiments provide a prepreg composition (comprising at least one fiber layer impregnated with a prepreg resin), methods for making prepreg compositions (comprising contacting fibers with a prepreg resin), composite materials formed from the prepreg compositions, and composite structures comprising the composite materials. Preferred prepreg compositions are suitable for making a wide variety of composite structures (including primary and secondary aircraft structures and sports equipment) by various manufacturing methods, including hand layup and automated tape laying (ATL). Self-adhesive prepreg compositions suitable for use in making honeycomb sandwich structures are particularly preferred.

Preferred prepreg compositions comprise at least one fiber layer impregnated with a prepreg resin. Fibers suitable for inclusion in the prepreg include glass fiber, synthetic polymer fiber (e.g., Kevlar® aromatic polyamide fibers commercially available from DuPont), ceramic fiber, carbon fiber, quartz fiber, polyethylene fiber, boron fiber, and hybrids thereof. The fibers may be in various forms, e.g., single tows, unidirectional tape, or fabric. A wide variety of suitable fibers are commercially available.

Preferred prepreg resins comprise a thermosetting resin, a curing agent, a thermoplastic viscosity control agent, and a thermoplastic toughening agent. A wide variety of thermosetting resins is commercially available and/or known to those skilled in the art, and may be selected based on the intended function of the resulting cured composite material. The disclosure of U.S. Pat. No. 6,440,257 is hereby incorporated by reference in its entirety and particularly for the purpose of describing examples of thermosetting resins and their uses. Examples of preferred thermosetting resins include epoxy resin, cyanate ester resin, polyamide resin, and polyimide resin (e.g., bismaleimide). Preferred epoxy resins include bisphenol-F-diglycidyl ether, bisphenol-A-diglycidyl ether, triglycidyl ether of para-aminophenol, epoxy phenol novalac, epoxy cresol novalac, and N,N,N′,N′-tetraglycidyl-4,4-methylenebisbenzenamine. Preferably, the thermosetting resin contains backbone functional groups that are similar and/or compatible with the backbone functional groups of the thermoplastic viscosity control agent.

Thermosetting resins are typically cured by chemical reaction using a curing agent (often accelerated by heating). The thermosetting resin preferably functions as a matrix precursor that is converted to a polymer matrix when cured in the presence of fibers dispersed therein. The selection of the type and amount of curing agent is preferably based on the type and amount of the thermosetting resin that the curing agent is intended to cure, according to principles well known to those skilled in the art. The curing agent may become part of the structure of the cured resin (e.g., the amino group of an amine curing agent typically reacts with an epoxy group of an epoxy resin, thereby forming a chemical bond), or the curing agent may function as a catalyst. Examples of various curing agents are disclosed in U.S. Pat. No. 6,440,257, which is hereby incorporated by reference for the purpose of describing curing agents and their uses. Amines are preferred curing agents for epoxy resins. Examples of preferred amine curing agents include 4,4′-diaminodiphenyl sulfone, dicyandiamide, and mixtures thereof.

The thermoplastic viscosity control agent and thermoplastic toughening agent of the present invention are, contrary to conventional wisdom, preferably substantially or completely dissolved in the prepreg resin. Preferably, more than 10%, more preferably more than about 20%, even more preferably more than about 50%, of the thermoplastic viscosity control agent is soluble in the prepreg resin, by weight based on the total weight of the thermoplastic viscosity control agent in the prepreg resin, as measured at about 25° C. Most preferably, virtually the entire thermoplastic viscosity control agent is soluble in the prepreg resin at about 25° C.

The thermoplastic viscosity control agent may be selected from a variety of thermoplastics. The selection of the type and amount of thermoplastic viscosity control agent is preferably based on its solubility characteristics and the type and amount of the thermosetting resin present in the prepreg resin. Examples of preferred thermoplastic viscosity control agents include polyhydroxyether, polyether, polyether sulfone, polyetherether sulfone, polyether sulfone/etherether sulfone copolymer, polysulfide, cresol novolac, phenol novolac, epoxy cresol novolac, epoxy phenolic novolac, polyvinyl butyral (PVB), polyvinyl chloride (PVC), polyvinyl alcohol, polyvinyl acetate, polyvinyl formal (PVF), acrylonitrile containing rubber, and polyimide. Preferably, the thermoplastic viscosity control agent contains backbone functional groups that are similar and/or compatible with the backbone functional groups of the thermosetting resin. Thus, for example, polyhydroxyethers are preferred thermoplastic viscosity control agents for epoxy-type thermosetting resins. The polyhydroxyether with the trade name PKHB-100 (commercially available from Phenoxy Resins) is a particularly preferred thermoplastic viscosity control agent.

The thermoplastic viscosity control agent is a thermoplastic that is present in the prepreg resin in an amount that increases the viscosity of the neat (without solvent) prepreg resin, as compared to a comparable prepreg resin that contains a smaller amount of that thermoplastic.

Preferably, the thermoplastic viscosity control agent is present in the prepreg resin in an amount that results in a prepreg resin minimum viscosity in the range of about 25 poise to about 1500 poise, more preferably in the range of about 25 poise to about 250 poise, even more preferably in the range of about 40 poise to about 75 poise, as measured on a neat (without solvent) prepreg resin sample at a heating rate of 2° C. per minute by Rheometrics at a frequency of 10 radians/sec and a strain of 50%.

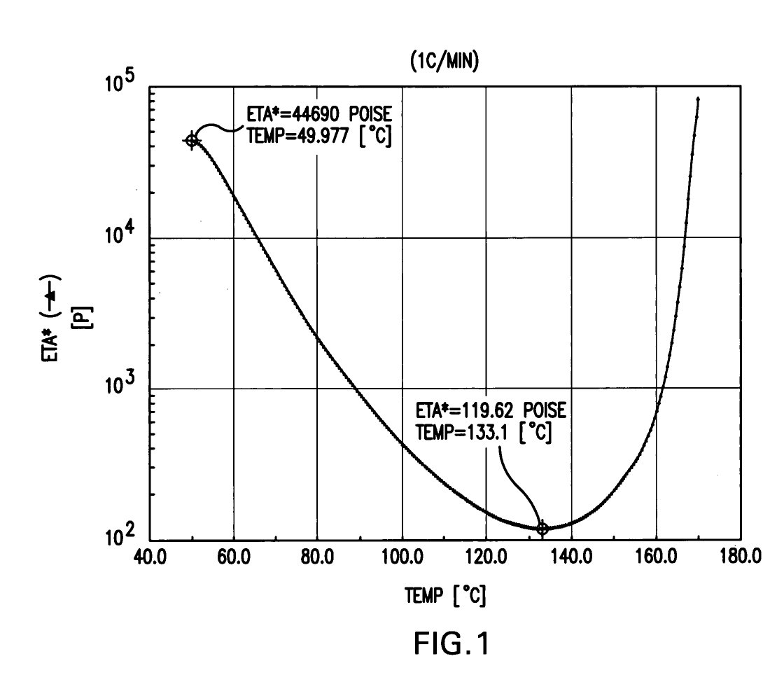

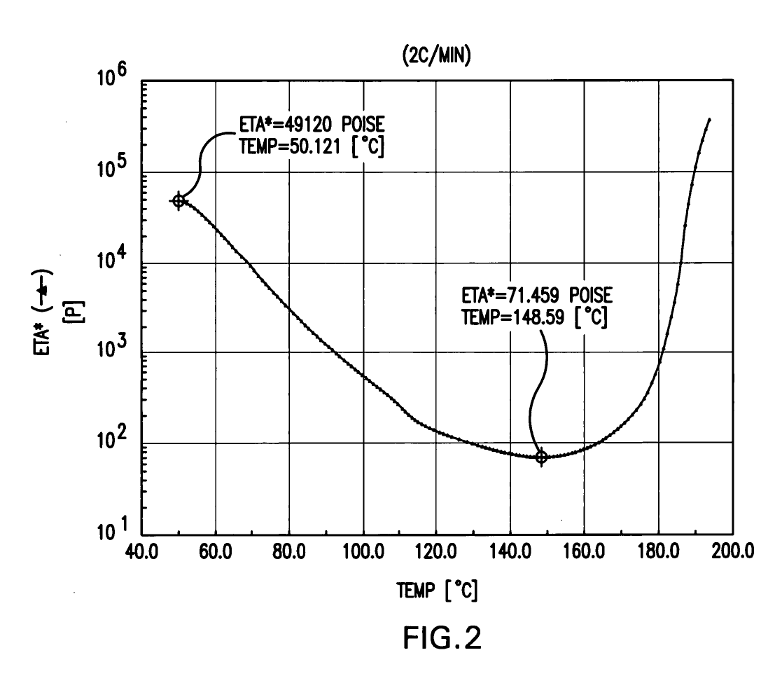

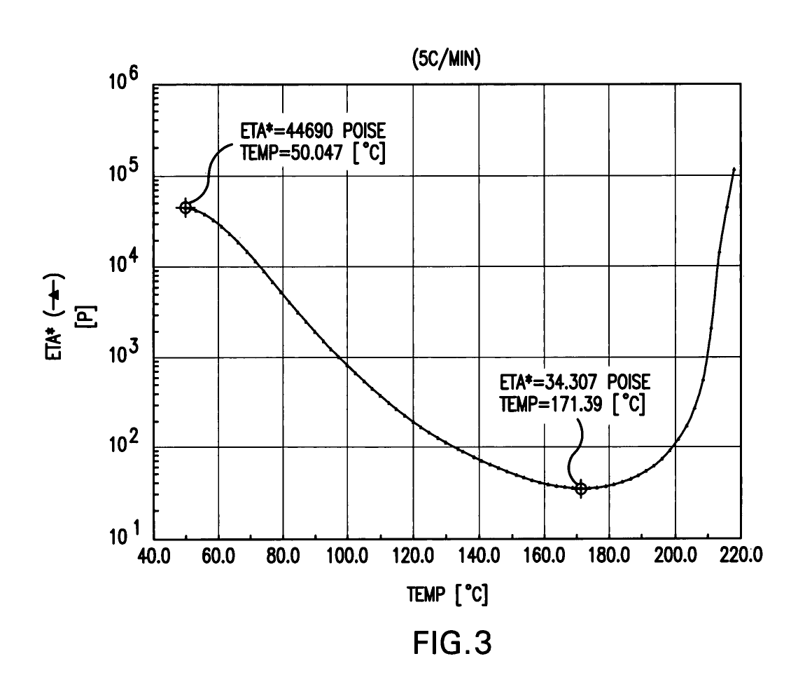

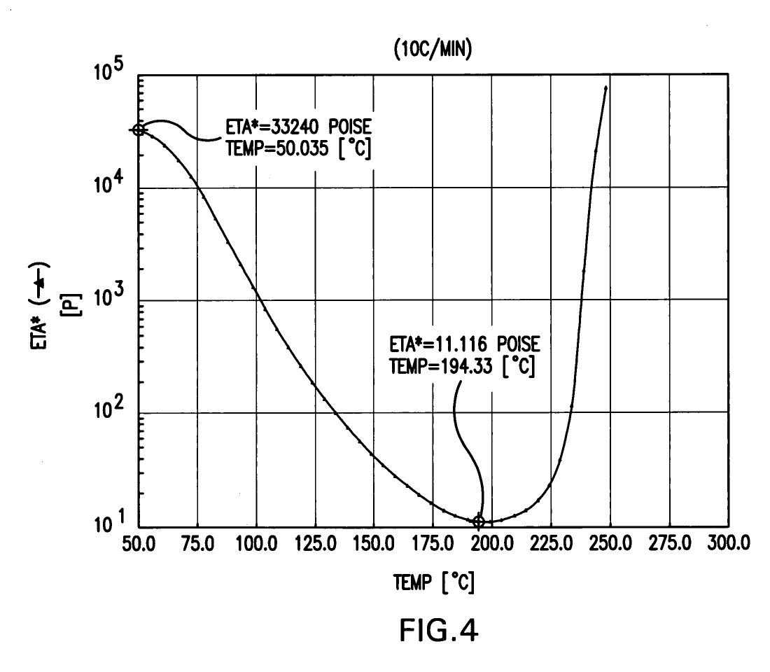

FIGS. 1 to 4 illustrate the Rheometrics of samples of a preferred embodiment of the prepreg resin of the present invention, formed as in Example 1, at four rates: 1° C./minute; 2° C./minute; 5° C./minute and; 10° C./minute. These figures illustrate the viscosity (Eta) at various temperatures during heating of the prepreg resin for each of the heating rates shown. The preferred heating rate is 2° C./minute and is thus, used to illustrate the preferred viscosity characteristics of the prepreg resin of the present invention. Different formulations of the present invention other than in Example 1 will affect the minimum viscosity achieved during the heating process.

The amount of thermoplastic viscosity control agent and the extent to which it increases the viscosity of the neat prepreg resin tends to vary depending on the type of thermoplastic and its molecular weight. Typically, the amount of thermoplastic viscosity control agent in the prepreg resin is in the range of about 0.5% to about 15%, more preferably about 1% to about 10%, by weight based on the total weight of the prepreg resin, although larger or smaller amounts may occasionally be used. The effectiveness of the thermoplastic viscosity control agent tends to be a function of its molecular weight, such that, on an equal weight basis, higher molecular weight thermoplastics generally increase viscosity more than lower molecular weight thermoplastics. Preferably, the number average molecular weight Mn (in Daltons) of the thermoplastic viscosity control agent is in the range of about 9,000 to about 16,000, more preferably in the range of about 9,000 to about 11,000. The thermoplastic viscosity control agent preferably has a solution viscosity as measured in a 20% cyclohexane solution at 25° C. in the range of about 180 centipoise to about 900 centipoise, more preferably in the range of about 175 centipoise to about 425 centipoise.

The thermoplastic toughening agent is preferably also substantially or completely dissolved in the prepreg resin. The thermoplastic toughening agent is a thermoplastic that is present in the prepreg resin in an amount that increases the toughness of the composite material prepared from the prepreg composition, as compared to a comparable composite material that contains a smaller amount of that thermoplastic. Toughness may be determined by Boeing Standard Method BSS 7260 (compression after impact (CAI) test) or by a mode 1 fracture toughness test known to those skilled in the art as GIC. Preferably, more than 10%, more preferably more than about 20%, even more preferably more than about 50%, of the thermoplastic toughening agent is soluble in the prepreg resin, by weight based on the total weight of the thermoplastic toughening agent in the prepreg resin, as measured at about 25° C. Most preferably, virtually all of the thermoplastic toughening agent is soluble in the prepreg resin at about 25° C. The solubility of the thermoplastic viscosity control agent and the thermoplastic toughening agent in the prepreg may be determined by optical microscopy at a magnification of 300× and at a temperature of 25° C. Thus, particles of the thermoplastic viscosity control agent and the thermoplastic toughening agent are considered to be insoluble if they are visible in the prepreg resin using optical microscopy at a magnification of 300× at a temperature of 25° C.

The amount of thermoplastic toughening agent and the extent to which it increases the toughness of the resulting composite material tends to vary depending on the type of thermoplastic and its molecular weight. Typically, the amount of thermoplastic toughening agent in the prepreg resin is in the range of about 20% to about 35%, more preferably about 25% to about 30%, by weight based on the total weight of the prepreg resin, although larger or smaller amounts may occasionally be used. The effectiveness of the thermoplastic toughening agent tends to be a function of its molecular weight, such that, on an equal weight basis, higher molecular weight thermoplastics generally increase toughness more than lower molecular weight thermoplastics. Preferably, the number average molecular weight Mn of the thermoplastic toughening agent is in the range of about 6,000 to about 12,000, more preferably in the range of about 9,000 to about 12,000.

The thermoplastic toughening agent may be selected from a variety of thermoplastics. The selection of the type and amount of thermoplastic toughening agent is preferably based on the type and amount of the thermosetting resin present in the prepreg resin, the solubility characteristics of the thermoplastic, and the toughness of the thermoplastic when not incorporated into a composite. U.S. Pat. No. 6,437,080 is hereby incorporated by reference in its entirety and particularly for the purpose of describing thermoplastics useful as thermoplastic toughening agents. Polyether sulfone, polyetherether sulfone, and copolymers thereof are examples of preferred thermoplastic toughening agents. The polyether sulfone/etherether sulfone (PES/PEES) copolymers described in the working examples of U.S. Pat. No. 6,437,080 are particularly preferred thermoplastic toughening agents.

The combined amount of thermoplastic viscosity control agent and thermoplastic toughening agent in the prepreg resin is preferably in the range of about 25% to about 40%, more preferably about 30% to about 35%, by weight based on total prepreg resin weight. The categorizations are not mutually exclusive because a thermoplastic viscosity control agent may exhibit a toughening effect and a thermoplastic toughening agent may increase viscosity, although in any particular prepreg resin the thermoplastic viscosity control agent is different from the thermoplastic toughening agent.

Prepreg resins may contain one or more other additives known to those skilled in the art such as inorganic particles, colorants, stabilizers, catalysts, flame retardants, etc. Preferred prepreg resins are substantially free of thermoplastic fillet forming particles which are not dissolved to a substantial degree in the prepreg resin such as those disclosed in U.S. Pat. No. 6,440,257.

Prepreg resins may be prepared by intermixing, in any order, a thermosetting resin, a curing agent, a thermoplastic viscosity control agent, and a thermoplastic toughening agent, along with any other optional additives. Preferably, a solvent is also intermixed with the foregoing ingredients to facilitate good mixing and homogeneity. The selection of the type and amount of solvent is preferably based on the type and amount of the ingredients in the prepreg resin. Preferably, sufficient solvent is used to substantially dissolve all of the ingredients, thereby producing a substantially homogeneous prepreg resin composition. The prepreg resin containing the solvent may be used to impregnate fibers, or the solvent may be partially evaporated (or substantially completely evaporated from the prepreg resin to produce a neat prepreg resin) and the resulting prepreg resin used to impregnate fibers. Examples of suitable solvents include methylene chloride, dimethylformamide, tetrahydrofuran and, preferably, acetone, methyl ethyl ketone and 1,3 dioxolane.

Neat prepreg resin may also be prepared by intermixing, in any order, a thermosetting resin, a curing agent, a thermoplastic viscosity control agent, and a thermoplastic toughening agent, along with any other optional additives, in the absence of solvent. It is understood that one or more of the active ingredients may act as a solvent for one or more of the other active ingredients, but in this context the term “solvent” is not used to refer to such active ingredients. Intermixing of the ingredients in the absence of a solvent is preferably conducted with heating, and more preferably is conducted in a plurality of stages. For example, in a preferred embodiment, a pre-mix comprising a first portion of the thermoplastic toughening agent and part or all of at least one of the other ingredients (e.g., at least a portion of the thermosetting resin, and/or at least a portion of, and more preferably all, of the thermoplastic viscosity control agent) is formed in a first stage by intermixing the aforementioned ingredients, preferably with heating, more preferably with heating to a temperature higher than about 40° C. Preferably, substantially most or substantially all of the first portion of the thermoplastic toughening agent and the thermoplastic viscosity control agent is soluble in the pre-mix. Preferably, the pre-mix does not contain the curing agent, thus allowing for the achievement of better mixing at higher temperatures and lower viscosities, without premature curing.

The premix is then intermixed with at least a second portion of the toughening agent, and optionally further portions of the toughening agent and/or any remaining portions of the other ingredients (e.g., any remaining portions of the thermosetting resin, curing agent, and/or thermoplastic viscosity control agent). The second portion of the of the thermoplastic toughening agent may optionally comprise particles of the thermoplastic toughening agent, e.g., particles having a number average particle size in the range of 60 microns to 150 microns. For mixing conditions in which the added particles of the thermoplastic toughening agent do not dissolve, the relative amounts of the thermoplastic toughening agent in the first and second portions are preferably such that more than 10%, more preferably more than about 25%, even more preferably more than about 50%, of the thermoplastic toughening agent is soluble in the resulting prepreg resin, by weight based on the total weight of the thermoplastic toughening agent in the resulting prepreg resin, as measured at about 25° C.

Prepreg compositions are preferably formed by impregnating or “prepregging” the fibers with the prepreg resin, e.g., by contacting a plurality of fibers with the prepreg resin such that the individual fibers are reasonably well coated with the prepreg resin. Various methods for contacting the fibers with the prepreg resin are known to those skilled in the art, including solution and bulk methods. For example, in a preferred embodiment, fibers in the form of a unidirectional tape or woven fabric are passed through a bath that contains a prepreg resin. The resulting prepreg composition (containing fibers and prepreg resin) may then be treated mechanically to remove any excess prepreg resin, e.g., by passing the prepreg composition through a pair a rollers having a pre-set gap. Any solvent is typically permitted to evaporate, or evaporation may be encouraged by passing the prepreg composition through a drying oven. The final prepreg composition is preferably substantially free of solvent, and preferably contains from about 35% to about 45% of prepreg resin, more preferably from about 38% to about 42% of prepreg resin, by weight based on total prepreg composition weight.

Composite materials may be made from the prepreg compositions by methods known to those skilled in the art. For example, in a preferred embodiment, a pair of two-ply carbon fiber prepregs are layed up to form a pair of prepreg face sheets, which are then applied to the opposite sides of a Nomex® honeycomb core without the use of an adhesive (+45, 0/90, core, 0/90, +45). The resulting structure is then vacuum bagged and cured in an autoclave per Boeing BMS 8-256 for 2 hours at 350° F. at heating rates in the range of about 1° F. per minute to about 5° F. per minute to form a honeycomb sandwich structure. Climbing drum peel tests (ASTM D 1781) show that the face sheets are well bonded to the honeycomb core, and microscopic examination of a cross-sectioned sample shows proper fillet formation, indicating that desirable flow of the prepreg resin during curing is achieved. Preferred honeycomb sandwich structures and laminates fabricated using the prepreg compositions described herein also have excellent toughness as determined by compression-after-impact (CAI) and mode 1 fracture toughness (G1C) tests conducted on laminates.

### EXAMPLE 1

A prepreg resin is made as follows: A thermosetting resin containing a mixture of epoxy resins is prepared by mixing 12.4 grams of bisphenol-F-diglycidyl ether (trade name PY 306) and 37.2 grams of diglycidyl ether of para-aminophenol (trade name MY 0510) with heating at about 90° C. A first portion of a thermoplastic toughening agent (14.1 grams of a 40:60 polyether sulfone/polyetherethersulfone copolymer having a number average molecular weight of about 11,000, prepared as described in U.S. Pat. No. 6,437,080), is slowly added to the mixture of epoxy resins. A thermoplastic viscosity control agent (5.04 grams of polyhydroxyether, trade name PKHB-100) is also added to the mixture of epoxy resins. The resulting mixture is heated at about 90° C. until both the thermoplastic toughening agent and the thermoplastic viscosity control agent dissolve. The resulting mixture is then cooled to about 40-50° C. and about 40 grams of acetone is added to form a concentrated solution. A second portion of the thermoplastic toughening agent (14.1 grams of the polyether sulfone/polyetherethersulfone copolymer described above) is then added to the concentrated solution with stirring at about 40-50° C. until the thermoplastic toughening agent dissolves (about 30 minutes). A curing agent (a mixture of 15.7 grams 4,4′-diaminodiphenyl sulfone and 1.38 grams dicyandiamide) is then added to the solution to form the prepreg resin.

### EXAMPLE 2

A prepreg resin is made as follows: A thermosetting resin containing a mixture of epoxy resins is prepared by mixing 12.4 grams of bisphenol-F-diglycidyl ether (trade name PY 306) and 37.2 grams of triglycidyl ether of para-aminophenol (trade name MY 0510) with heating at about 90° C. The entire thermoplastic toughening agent (28.2 grams of a 40:60 polyethersulphone/polyetherethersulphone copolymer described in example 1), is slowly added to the mixture of epoxy resins. A thermoplastic viscosity control agent (5.04 grams of polyhydroxyether, trade name PKHB-100) is also added to the mixture of epoxy resins. The resulting mixture is heated at about 90° C. until both the thermoplastic toughening agent and the thermoplastic viscosity control agent dissolve. The resulting mixture is then cooled to about 40-50° C. and about 40 grams of acetone is added to form a concentrated solution. A curing agent (a mixture of 15.7 grams of 4,4′diaminodiphenyl sulphone and 1.38 grams of dicyandiamide) is then added to the solution to form a prepreg resin.

### EXAMPLE 3

A prepreg composition is prepared as follows: A plain weave carbon fabric (containing T300 3K never twisted carbon fibers) having a weight of 190 to 200 grams per square meter is run through a prepreg resin prepared as described in Example 1 at a rate of about 1 to about 5 meters/minute and then through an oven held at about 80°-120° C. to evaporate the acetone solvent. A dip and flow process or a nip gap are used to impregnate the fabric with the desired amount of prepreg resin. The resulting prepreg composition contains about 38%-42% prepreg resin, by weight based on total prepreg composition weight.

A sample of prepreg resin is obtained from the prepreg composition by compressing the prepreg composition in a press. The sample of prepreg resin is examined at 25° C. by optical microscopy (300×). No particles of thermoplastic viscosity control agent or thermoplastic toughening agent are observed, indicating that virtually all of the thermoplastic viscosity control agent and thermoplastic toughening agent are soluble in the prepreg resin.

### EXAMPLE 4

A prepreg resin is made as follows: A pre-mix is prepared by mixing a thermosetting resin (20 grams of bisphenol-F-diglycidyl ether, trade name PY 306) with a first portion of a thermoplastic toughening agent (7.1 grams of the polyether sulfone/polyetherethersulfone copolymer described in Example 1) and a thermoplastic viscosity control agent (5.04 grams of polyhydroxyether, trade name PKHB-100). The resulting mixture is heated with stirring at about 90°-130° C. to dissolve both the first portion of the thermoplastic toughening agent and the thermoplastic viscosity control agent. The resulting pre-mix is then cooled to about 40-50° C. and added to an additional portion of thermosetting resin (containing 5.4 grams of the bisphenol-F-diglycidyl ether and 25.0 grams of diglycidyl ether of para-aminophenol) and a second portion of the thermoplastic toughening agent (21.1 grams of the polyether sulfone/polyetherethersulfone copolymer described above) are added with stirring. A curing agent (a mixture of 15.7 grams 4,4′-diaminodiphenyl sulfone and 1.38 grams dicyandiamide) is then added with stirring to form the prepreg resin.

### EXAMPLE 5

A prepreg resin is made as follows: A pre-mix is prepared by mixing a thermosetting resin (10.8 grams of bisphenol-F-diglycidyl ether, trade name PY 306) and (36.4 grams of triglycidyl ether of para-aminophenol, trade name MY 0510) and a thermoplastic toughening agent (28.2 grams of the polyethersulphone/polyetherethersulphone copolymer described in example 1) and a thermoplastic viscosity control agent (5.04 grams of polyhydroxyether, trade name PKHB-100). The resulting mixture is heated with stirring at about 90°-130° C. to dissolve both the thermoplastic toughening agent and the thermoplastic viscosity control agent. The resulting pre-mix is then cooled to about 40°-50° C. and about 5 grams of 1,3 dioxolane is added to the mixture with stirring. A curing agent (15.7 grams of 4,4′ diaminodiphenyl sulfone is then added with stirring to the mixture. A catalyst agent (a mixture of 1.50 grams of bisphenol-F-diglycidyl ether, trade name PY 306 and 1.50 grams of dicyandiamide) is then added with stirring to form a prepreg resin.

### EXAMPLE 6

Honeycomb sandwich structures and test coupons are fabricated using prepreg compositions prepared as described in Example 3, in accordance with the standard procedures used to fabricate such structures for testing by the mechanical tests described in Example 8 below.

### COMPARATIVE EXAMPLE 7

A control prepreg composition is prepared using a procedure similar to that of Example 3, except that the prepreg resin is a carboxyl-terminated butadiene nitrile (CTBN) rubber-modified epoxy resin currently qualified for use on secondary aircraft structures. Honeycomb sandwich control structures are fabricated in accordance with the procedures used to fabricate such structures for testing by ASTM D 1781 (Climbing Drum Peel) using the control prepreg composition. Two sets of control structures are fabricated, one with a film adhesive (a CTBN rubber-modified epoxy different from the matrix) that is used to adhere the honeycomb cores to the face sheets, and the other without the film adhesive. The honeycomb sandwich control structures with the film adhesive are currently qualified for use on secondary aircraft structures.

Table 1 shows the resulting Climbing Drum Peel test data for both sets of structures. The test data shows that the film adhesive significantly improves the mechanical properties of the honeycomb sandwich structures, and that removing the film adhesive from the currently-qualified material produces a detrimental reduction in mechanical properties.

TABLE 1

| | Control CTBN | | Control | |
|---|---|---|---|---|
| | epoxy matrix | | CTBN epoxy | |
| | (without film adhesive) | | matrix (with film adhesive) | |
| | tool-side (in- | bag-side | tool-side (in- | bag-side |
| Test | lb/3 in) | (in-lb/3 in) | lb/3 in) | (in-lb/3 in) |
| Climbing Drum | 9-11 | 8-12 | 24-27 | 26-28 |
| Peel (RT 0 day) | | | | |

### EXAMPLE 8

Honeycomb sandwich structures and test coupons fabricated as described in Examples 4-5 are subjected to the following mechanical tests, which are often used by those skilled in the art to gain the confidence that the structure will demonstrate the desired mechanical properties for a particular application:

Climbing Drum Peel (ASTM D 1781): This test is typically used to measure the adhesive strength of a face panel to the surface of the honeycomb core. The test measures the peel resistance of adhesive bonds between the relatively flexible facing of a sandwich structure and its core. This test is primarily used to assess structures for consideration in secondary structure applications on commercial aircraft.

Long Beam Flex (ASTM C 393-94): This test is typically used to characterize the mechanical properties of a flat sandwich structure that is subjected to flatwise curvature in a manner that the applied moments produce curvature of the sandwich facing planes causing compressive failure on the top-side facings and tension failure on the bottom-side facings. This test is primarily used to assess structures for consideration in secondary structure applications on commercial aircraft.

Flatwise Tension (ASTM C 297-94): This test is typically used to characterize the core flatwise tension strength, or the strength of the bond between the core and the facings of an assembled sandwich panel. The test involves subjecting a sandwich panel to a tensile load normal to the plane of the panel, such load being transmitted to the sandwich through thick loading blocks bonded to the sandwich facings. This test is primarily used to assess structures for consideration in secondary structure applications on commercial aircraft.

Compression After Impact (CAI, Boeing Standard Method BSS 7260): This test is typically used to characterize the compressive strength of a structure after impacting the structure at a specific energy level. After impact the structure is subjected to compressive loadings at relatively low uniform rates of strain. This test provides data regarding the toughness of the resin system. This test is primarily used to assess structures for consideration in primary structure applications on commercial aircraft.

G1C: This test is typically used to characterize the shear properties of the matrix using a crack starter to initiate a failure mode between the plies within a cured laminate. The plies are pulled apart in mode 1 failure. The test provides data as to the toughness of the resin system. This test is primarily used to assess structures for consideration in primary structure applications on commercial aircraft.

Table 2 shows test data for honeycomb sandwich structures and coupons fabricated using self-adhesive prepreg as described in Example 6, as well as data obtained on a series of control structures having a CTBN rubber-modified epoxy matrix and fabricated with the film adhesive described in Example 5. As indicated in Example 7, the film adhesive provides the control structures with mechanical properties superior to that of structures fabricated without the film adhesive and sufficient to qualify for use on secondary aircraft structures.

The data in Table 2 shows that the honeycomb sandwich structures and coupons prepared as described herein meet customer specifications and in some cases exceed the performance of the control products, especially when toughness of the resin system is of importance. Advantages for the manufacturer include reductions in labor costs and material costs, as well as reductions in weight (and increased strength/weight).

TABLE 2

| Test | Self-Adhesive Prepreg | | Control | |
|---|---|---|---|---|
| Long Beam Flexure | load (lbf) | P/Y lbf/in. | load (lbf) | P/Y lbf/in. |
| (2 ply quasi) | 250-260 | 170-185 | 260-275 | 160-170 |
| Long Beam Flexure (2 | load (lbf) | P/Y lbf/in. | load (lbf) | P/Y lbf/in. |
| ply quasi 200° F. wet) | 185-195 | 160-170 | 175-185 | 140-150 |
| Climbing Drum Peel | tool-side | bag-side | tool-side | bag-side |
| (RT 0 day) | (in-lb/3 in) | (in-lb/3 in) | (in-lb/3 in) | (in-lb/3 in) |
| | 24-27 | 22-25 | 24-27 | 26-28 |
| Climbing Drum Peel | tool-side | bag-side | tool-side | bag-side |
| (RT 10 day out-time) | (in-lb/3 in) | (in-lb/3 in) | (in-lb/3 in) | (in-lb/3 in) |
| | 22-23 | 23-25 | 24-28 | 27-28 |
| Climbing Drum Peel | tool-side | bag-side | tool-side | bag-side |
| (160° F./wet) | (in-lb/3 in) | (in-lb/3 in) | (in-lb/3 in) | (in-lb/3 in) |
| | 24-26 | 22-25 | 27-29 | 25-27 |

| | | |
|---|---|---|
| Flatwise Tension | Strength (psi) | Strength (psi) |
| (Ambient) | 775-790 | 770-780 |
| G1C | in*lbf/in² | in*lbf/in² |
| | 5.9-6.3 | 2.2-2.6 |
| Compression After | Strength (ksi) | Strength (ksi) |
| Impact | 40-43 | 26-28 |

All literature references and patents mentioned herein are hereby incorporated by reference in their entireties. Although the foregoing invention has been described in terms of certain preferred embodiments, other embodiments will become apparent to those of ordinary skill in the art in view of the disclosure herein. Accordingly, the scope of the present invention is not limited by the recitation of preferred embodiments.

What is claimed is:

1. A prepreg composition comprising at least one fiber layer impregnated with a prepreg resin;
the prepreg resin comprising a thermosetting resin, a curing agent, a thermoplastic viscosity control agent, and a thermoplastic toughening agent, the combined amounts of the thermoplastic viscosity control agent and the thermoplastic toughening agent being in the range of about 25% to about 40%, by weight based on total prepreg resin weight;
wherein more than 10% of each of the thermoplastic viscosity control agent and the thermoplastic toughening agent are soluble in the prepreg resin, by weight based on the total weight of each of the thermoplastic viscosity control agent and the thermoplastic toughening agent, respectively, as measured at about 25° C.; and
wherein the prepreg resin has a minimum viscosity in the range of about 25 poise to about 1500 poise as measured on a neat prepreg resin sample at a heating rate of 2° C. per minute.

2. The prepreg composition of claim 1 in which the minimum viscosity is in the range of about 25 poise to about 250 poise.

3. The prepreg composition of claim 1 in which substantially all of the thermoplastic viscosity control agent is soluble in the prepreg resin.

4. The prepreg composition of claim 1 in which greater than about 20% by weight of the thermoplastic toughening agent is soluble in the prepreg resin.

5. The prepreg composition of claim 1 in which the prepreg resin is a substantially homogenous composition.

6. The prepreg composition of claim 1 in which the fiber layer comprises carbon fibers.

7. The prepreg composition of claim 1 in which the thermosetting resin is selected from the group consisting of epoxy resin, cyanate ester resin, polyamide resin and polyimide resin.

8. The prepreg composition of claim 7 in which the epoxy resin is selected from the group consisting of bisphenol-F-diglycidyl ether, bisphenol-A-diglycidyl ether, epoxy phenol novolac, epoxy cresol novolac, triglycidyl ether of para-aminophenol, and N,N,N′,N′-tetraglycidyl-4,4-methylenebisbenzenamine.

9. The prepreg composition of claim 1 in which the thermoplastic viscosity control agent is selected from the group consisting of polyhydroxyether, polyether sulfone, polyetherether sulfone, polyether sulfone/etherether sulfone copolymer, polyvinyl butyral, and polyvinyl formal.

10. The prepreg composition of claim 1 in which the thermoplastic toughening agent is selected from the group consisting of polyether sulfone, polyetherether sulfone, and copolymers thereof.

11. A method for making a prepreg composition, comprising:
forming a prepreg resin comprising a thermosetting resin, a curing agent, a thermoplastic viscosity control agent, and a thermoplastic toughening agent; the combined amounts of the thermoplastic viscosity control agent and the thermoplastic toughening agent being in the range of about 25% to about 40%, as measured by weight based on the total weight of a neat prepreg resin sample; wherein more than 10% of each of the thermoplastic viscosity control agent and the thermoplastic toughening agent are soluble in the prepreg resin, by weight based on the total weight of each of the thermoplastic viscosity control agent and the thermoplastic toughening agent, respectively, as measured at about 25° C.; wherein the prepreg resin has a minimum viscosity in the range of about 25 poise to about 1500 poise as measured on a neat prepreg resin sample at a heating rate of 2° C. per minute; and
contacting a plurality of fibers with the prepreg resin.

12. The method of claim 11 in which the prepreg resin comprises a solvent.

13. The method of claim 12 in which the solvent is selected from the group consisting of acetone, 1,3 dioxolane, methyl ethyl ketone, methylene chloride, tetrahydrofuran and dimethylformamide.

14. The method of claim 12 further comprising evaporating the solvent.

15. The method of claim 11 in which the prepreg resin is a substantially homogenous composition.

16. The method of claim 11 in which substantially all of the thermoplastic viscosity control agent is soluble in the prepreg resin.

17. The method of claim 11 in which greater than about 20% by weight of the thermoplastic toughening agent is soluble in the prepreg resin.

18. The method of claim 11 in which the thermosettirig resin is selected from the group consisting of epoxy resin, cyanate ester resin, polyamide, and polyimide.

19. The method of claim 11 in which the thermoplastic viscosity control agent is selected from the group consisting of polyhydroxyether, polyether, polyether sulfone, polyetherether sulfone, polyether sulfone/etherether sulfone copolymer, polysulfide, cresol novolac, phenol novolac, epoxy cresol novolac, epoxy phenol novolac, polyvinyl butyral, polyvinyl chloride, polyvinyl alcohol, polyvinyl acetate, polyvinyl formal, acrylonitrile containing rubber, and polyimide.

20. The method of claim 11 in which the thermoplastic toughening agent is selected from the group consisting of polyether sulfone, polyetherether sulfone, and copolymers thereof.

21. The method of claim 11 in which the forming of the prepreg resin comprises:
forming a pre-mix comprising a first portion of the thermoplastic toughening agent and at least one ingredient selected from the group consisting of at least a portion of the thermosetting resin, at least a portion of the curing agent, and at least a portion of the thermoplastic viscosity control agent; wherein substantially all of the first portion of the thermoplastic toughening agent is soluble in the pre-mix; and
intermixing the pre-mix with at least a second portion of the thermoplastic toughening agent.

22. The method of claim 21 comprising forming the premix at a temperature higher than about 40° C.

23. The method of claim 21 in which the second portion of the thermoplastic toughening agent comprises particles of the thermoplastic toughening agent having a number average particle size in the range of 60 microns to 150 microns.

24. A composite structure comprising a composite material made by curing the prepreg composition of claim 1.

25. The composite structure of claim 24 in the form of a honeycomb sandwich structure.
